(19) United States
(12) Patent Application Publication
(10) Pub. No.: US 2012/0065996 A1
(43) Pub. Date: Mar. 15, 2012

(54) SYSTEM AND METHOD FOR COORDINATING THE COMMUNICATION OF HEALTH RELATED INFORMATION AND PRODUCTS TO A REGISTERED USER OF A PHARMACY

(75) Inventors: Michael Daoud, Mississauga (CA); Amir Besada, North York (CA); Hany Besada, North York (CA); John-Pierre Kamel, Toronto (CA)

(73) Assignee: Levitate Health Inc., Mississuaga (CA)

(21) Appl. No.: 12/949,928

(22) Filed: Nov. 19, 2010

(30) Foreign Application Priority Data
Nov. 18, 2009 (CA) 2,721,594

(51) Int. Cl. G06Q 50/00; G06Q 10/00

(52) U.S. Cl. 705/3

(57) ABSTRACT

A coordination server for facilitating the presentation of health related information over an electronic communication network to a plurality of users, such that each of the plurality of users is registered with a particular pharmacy store, the coordination server comprising: a registration module configured for receiving electronic registration information of a user including user identification data and pharmacy store identification data of the particular pharmacy store at which the user is registered; a user module configured for receiving electronic personal health information of the user including current user medication information and associated user condition information; a confirmation module configured for confirming the accuracy of the electronic personal health information with at least one of a health care professional of the pharmacy store or the user; a generation module configured for generating customized health related information for the user based on the confirmed electronic personal health information; and a communication module configured for receiving an electronic request from the user for health related information and for sending an electronic response including the customized health related information.

### CROSS-REFERENCE TO RELATED APPLICATIONS

This application claims priority to Canadian Patent Application No. ______, entitled “System and Method for Coordinating the Communication of Health Related Information and Products to a Registered User of a Pharmacy,” filed Nov. 18, 2010, the content of which is hereby incorporated by reference in its entirety.

### FIELD OF THE INVENTION

The present invention is related to coordination of electronic health information provided to a user of a pharmacy.

### BACKGROUND OF THE INVENTION

Direct access to health information by a patient is becoming increasingly important in today's increasingly complex health care system. Present health care environments include the ability for patients to gain access their health information through their health care professional both in paper form and electronically.

However, one disadvantage with current health information access is the need for the patient to book an appointment with their health care professional in order to gain access to their health information, and in particular to access any updates or changes to their health information. This situation can be problematic due to the busy schedules of both the patient and the health care professional.

A further disadvantage with current health information access is confirmation by the patient as to the understanding and/or direct knowledge of their health information by their health care professional. Patients need to be certain that their health care professional is apprised of the current state of the patient's health information in a timely manner. Further, there does not exist today any mechanism for the patient to update their own health information outside of an appointment (e.g. a real-time visit with a doctor or pharmacist in person and/or via telephone).

In terms of pharmacies, current access to health information (e.g. drug history, current medication summaries, health information related to medical condition and/or current medication) is cumbersome at best, in part due to privacy issues and in part due to the above identified general problems in the health care system.

### BRIEF DESCRIPTION OF THE DRAWINGS

Exemplary embodiments of the invention will now be described in conjunction with the following drawings, by way of example only, in which:

FIG. 1 is a block diagram of components of pharmacy customer management environment;

FIG. 2 is a block diagram of an example computing device for the customer of FIG. 1;

FIG. 3 is an illustration of different communication types between components of the environment of FIG. 1;

FIG. 4 shows example communication content between the components of FIG. 1;

FIG. 5 is an example embodiment of the servers of FIG. 1;

FIG. 6 is a further example embodiment of the servers of FIG. 1; and

FIG. 7 is an example configuration of the servers of FIG. 1.

### SUMMARY OF THE INVENTION

There is a need for a methods and systems for coordination of electronic health information provided to a user of a pharmacy that obviates or mitigates at least one of the above-presented disadvantages.

A first aspect provided is a coordination server for facilitating the presentation of health related information over an electronic communication network to a plurality of users, such that each of the plurality of users is registered with a particular pharmacy store, the coordination server comprising: a registration module configured for receiving electronic registration information of a user including user identification data and pharmacy store identification data of the particular pharmacy store at which the user is registered; a user module configured for receiving electronic personal health information of the user including current user medication information and associated user condition information; a confirmation module configured for confirming the accuracy of the electronic personal health information with at least one of a health care professional of the pharmacy store or the user; a generation module configured for generating customized health related information for the user based on the confirmed electronic personal health information; and a communication module configured for receiving an electronic request from the user for health related information and for sending an electronic response including the customized health related information.

A second aspect provided is a method for facilitating the presentation of health related information over an electronic communication network to a plurality of users, such that each of the plurality of users is registered with a particular pharmacy store, the method comprising the steps of: receiving electronic registration information of a user including user identification data and pharmacy store identification data of the particular pharmacy store at which the user is registered; receiving electronic personal health information of the user including current user medication information and associated user condition information; confirming the accuracy of the electronic personal health information with at least one of a health care professional of the pharmacy store or the user; generating customized health related information for the user based on the confirmed electronic personal health information; and receiving an electronic request from the user for health related information and for sending an electronic response including the customized health related information.

### DETAILED DESCRIPTION OF THE PREFERRED EMBODIMENT(S)

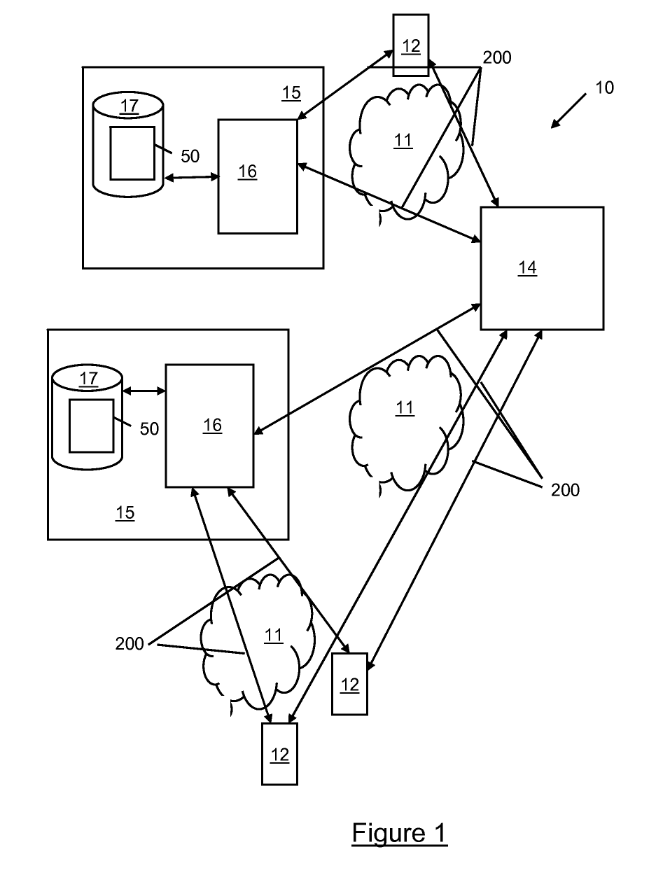

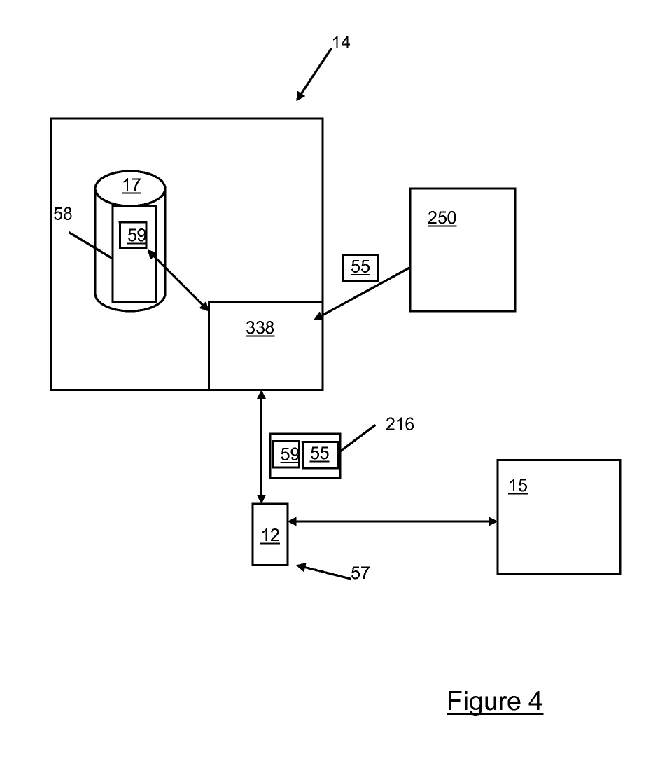

Referring to FIG. 1, shown is a pharmacy customer management environment 10 for facilitating various electronic communications 200 over a communications network 11 between a plurality of computing devices 12, one or more pharmacy coordination server(s) 14, and a plurality of pharmacy servers 16. Each user (e.g. a customer) is registered with a home or preferred pharmacy store 15, at which their respective patient medical profile 50 is stored in a storage 17 coupled with the pharmacy server 16 that is associated with the preferred pharmacy store 15 of the respective user. The coordination server 14 is configured for facilitating the presentation of health related information (via the electronic communications 200) over the electronic communication network 11 to a plurality of users 57 (see FIG. 4) operating the computing devices 12, such that each of the plurality of users 57 is registered with a particular pharmacy store 15 of the environment 10.

It is recognised that the present pharmacy management environment 10 can be applied to a number of different pharmacy brands, each having a number of respective pharmacy stores 15. For example, the pharmacy coordination server 14 can be configured to communicate over the communication network 11 with a number of pharmacy stores 15 for a particular brand and/or can be configured to communicate with a number of different pharmacy stores 15 for a plurality of pharmacy brands. It is also recognised that the pharmacy store 15 can be defined as a single physical pharmacy store frequented by the user, can be defined as a group of physical pharmacy stores frequented by the user, and/or can be defined as any of the physical pharmacy stores for a selected pharmacy brand (e.g. the pharmacy store 15 can be all stores associated with the CVS™ pharmacy brand). In terms of a national chain of pharmacy stores, the pharmacy store 15 can be defined as one or more physical stores that are associated with a selected geographical region (e.g. state, province, city, neighbourhood, etc.) or within a selected distance from the user's location (e.g. home address, GPS location of the user's device 12, etc.).

Preferably, the communications network 11 comprises a wide area network such as the Internet, however the network 11 may also comprise one or more local area networks 11, one or more wide area networks, or a combination thereof. Further, the network 11 need not be a land-based network, but instead may comprise a wireless network and/or a hybrid of a land-based network and a wireless network for enhanced communications flexibility. For example, the communications network 11 can also include Bluetooth™ associated elements. It is recognised that the servers 14,16 can communicate 200 with the computing devices 12 in a client server relationship, as further discussed below.

### Computing Device 12

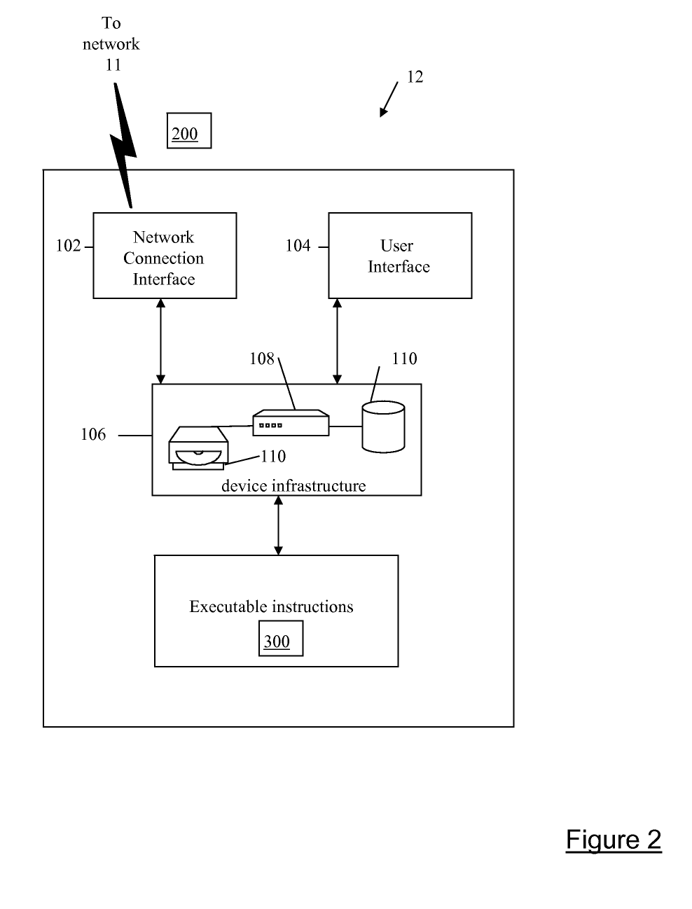

Referring to FIG. 2, each computing device 12 can comprise a land-based network-enabled personal computer. However, the invention is not limited for use with personal computers. For instance, one or more of the computing devices 12 may comprise a wireless communications device, such as a wireless-enabled (e.g. WiFi, WAN, etc.) personal data assistant, or e-mail-enabled wireless telephone if the network 11 is configured to facilitate wireless data communication. In addition, the communications 200 are not limited to only facilitating transmission of text data and may therefore be used to transmit image data, audio data or multimedia data, for example, as desired.

As shown in FIG. 2, the computing device 12 comprises a network interface 102, a user interface 104, and a data processing system 106 in communication with the network interface 102 and the user interface 104. Typically, the network interface 102 comprises an Ethernet network circuit card, however the network interface 102 may also comprise an RF antenna for wireless communication over the communications network 11. Preferably, the user interface 104 comprises a data entry device (such as keyboard, microphone or writing tablet), and a display device (such as a CRT or LCD display).

The data processing system 106 includes a central processing unit (CPU) 108, and a non-volatile memory storage device (e.g. DISC) 110 (such as a magnetic disc memory or electronic memory) and a read/write memory (RAM) 112 both in communication with the CPU 108. The memory 110 includes data which, when loaded into the RAM, comprise processor instructions for the CPU 108 which define memory objects for allowing the computing device 12 to communicate with the servers 14,16 over the communications network 11. The computing device 12, and the processor instructions for the CPU 108 will be discussed in greater detail below.

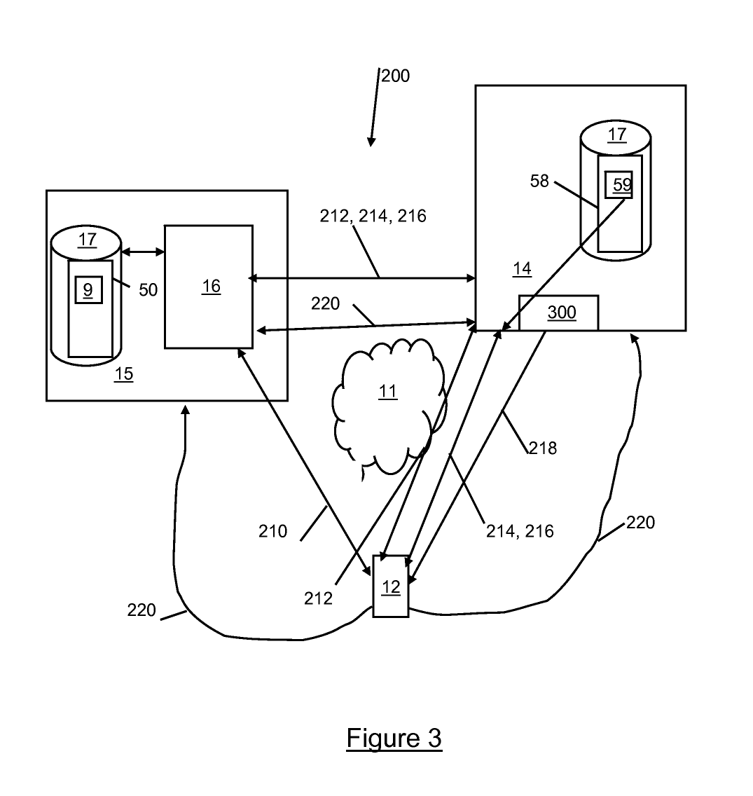

The CPU 108 is configured for execution of an application 300 (see FIG. 3) for facilitating communication between the servers 14,16 and the device 12 with respect to the example communication 200 types provide below as well as their respective content. For example, it is recognised that the application 300 is used to coordinate the communications 200 between the various devices 12,14,16 over the network 11, and as such the application 300 functionality can be implemented on any of and/or all of the devices 12,14,16 to facilitate the generation, receipt, and processing of the communications 200, including the pertinent data content of the communication 200 messages (e.g. both queries and responses) to an/or from the device 12. In one embodiment, the client application 300 is resident on the client device 12 and is configured to communicate in a client-server type relationship with a server side application 300 resident on the server 14 and/or server 16. The server application 300 is configured to provide data content to the client device 12 that can be pushed (e.g. as a notification) and/or in response to messages 200 received from the client device 12. alternatively, or in addition to, the client application 300 could be a generic (or somewhat specialized) browser that is in communication with a Web services server application 300, such that the communications 200 and corresponding data content are communicated via Web pages of the Web services application 300, as displayed on the user interface 104 of the client device 12. As further discussed below, the client application 300 provisioned on the device 12 can be a health application 300 as obtained from the coordination server 14. Alternatively, the client application 300 can be a browser suitable for interaction with the server application 300 implemented as a Web service, for example. In any event, it is recognised that the client/server applications 300 are used by the server 14 and the device 12c for exchange of electronic communications 200 there-between over the communications network 11.

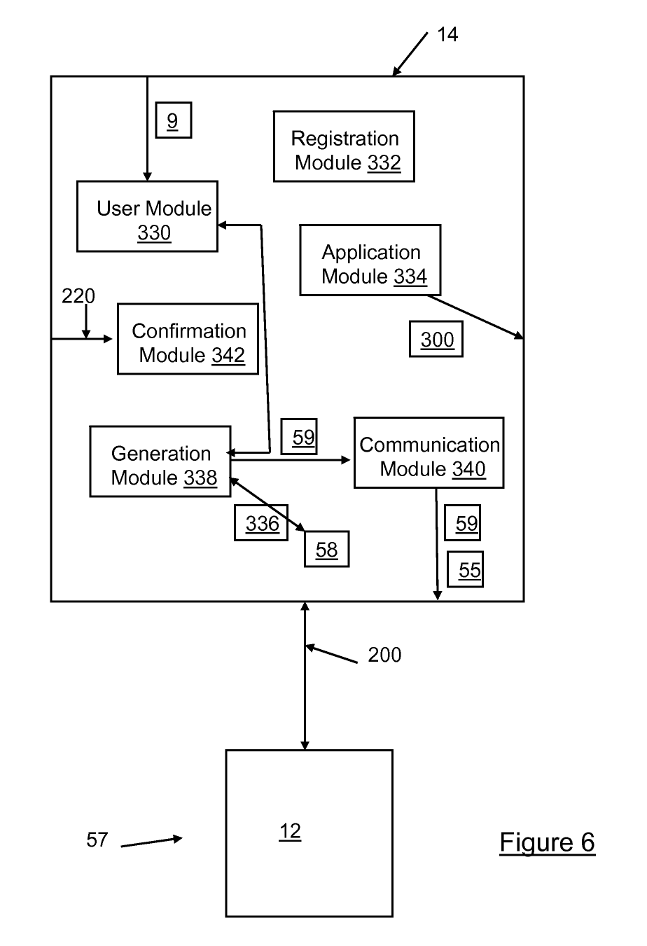

In one embodiment, the device 12 can be configured for communication with the coordination server 14 using a health application 300 suitable for provisioning on the device 12. For example, the device 12 can obtain the health application 300 from the coordination server 14 over the communications network 11. The application 300, once installed on the device 12, facilitates the transmission and reception of the messages 210,212,214,216 with the device 12 and the servers 14,16. For example, as shown in FIG. 6, an application module 334 is used by the coordination server 14 to facilitate provisioning the health application 300 on the device 12 for configuring the device 12 for communication with the coordination server 14, such that the health application 300 is customized based on the electronic registration information of the user 57. Once provisioned on the device 12, the device 12 is configured to communicate with the coordination server 14 (e.g. with a communications module 340). In this example, it is recognised that the server application 300 can be configured for communication with the health application 300 for receiving electronic request communications 200 and for sending the corresponding electronic response communications 200. The server application 300 can also be configured for communication with the health application 300 for receiving the electronic personal health information 9, and configured for communication with the health application 300 for receiving electronic update data to the electronic personal health information 9, as further described below.

Alternatively, the device 12 can be configured as having a browser application 300 provisioned on the device 12 that is suitable for communication (over the communications network 11) with the server application 300 provided as a Web service 200 on the coordination server 14. In this example, it is recognised that the Web service application 300 can be configured for communication with the browser application 300 for receiving electronic request communications 200 and sending the corresponding electronic response communications 200. The Web service application 300 can also be configured for communication with the browser application 300 for receiving the electronic personal health information 9, and configured for communication with the browser application 300 for receiving electronic update data to the electronic personal health information 9, as further described below.

Referring to FIGS. 1 and 3, it is recognised that each user uses the pharmacy customer management environment 10 to facilitate their various electronic communications 200 (including both requests and responses to such requests as well as pushed content messages), which include communications 200 such as but not limited to: pharmacist contact inquiry messages 210 between the user themselves and their preferred pharmacy store 15 (in particular with their pharmacist at their preferred pharmacy), such that these messages 210 can be communicated directly between the pharmacy store 15 and the computing device 12 (e.g. email, phone call, etc.) and/or can be communicated indirectly between the computing device 12 and the pharmacy store 15 via the coordination server 16; pharmacy event messages 212 informing the user of events that are scheduled at their registered pharmacy store 15; pharmacy product and/or services information messages 214 for those pharmacy product(s) and/or service(s) that are offered/provided by the preferred pharmacy store 15 of the user; and/or health information messages 216 having medical information content 59 related to medical electronic personal health information 9 of the user including current user medication information and associated user condition information. Examples of the electronic personal health information 9 can include data such as but not limited to: defining medical condition of the customer for known diseases or other medical conditions; defining the medication such as but not limited to prescription drugs of the customer and/or non-prescription drugs; and the sex, age, and/or lifestyle information of the user. In any event, the electronic personal health information 9 is used by the environment 10 to characterize the medication profile and medical condition profile of the user. The health information messages 216 can optionally contain product and/or service information data 55 as related to those products and/or services available to the customer from their preferred pharmacy store 15.

It is recognised that the communications 200 can be sent and/or received between two or more devices 12,14,16 via the communications network 11. Optionally, or in addition to, the communications 200 can be generated locally on the device 12 (e.g. reminder communications 200) for those devices 12 having a locally installed version of the health application 300. Local generation of communications 200 can be implemented as per the configuration of the local health application 300 (for example as downloaded from the server 14, 16 and/or as manually configured by the user) and/or via instruction from the server application 300 (e.g. configuration of communications 212 sent to the local health application 300 on the device 12 from the server 14, the server 16, etc.).

The Messages 200 screen (e.g. page) of the application 300 (e.g. provided by either the health application 300 provisioned on the device 12 and/or by the server application 300 as content accessed by the browser application 300 of the device 12) can display or otherwise indicate (via the user interface 104) all of the messages and communications 200 being indicated (e.g. sent to) on the device 12 by the application 300. This communication 200 can include communications such as but not limited to: Refill Reminders and Delivery Requests, Clinic Days, Home Pharmacy Events, and Med Check Days. For example, the application 300 can have a Messages menu option that can appear highlighted on a Patient Profile Main Menu screen of the application 300. In this case, when there are messages 200 waiting for user (where user action is required such as reading/opening/listening to the message 200, responding to the message 200, deleting the reminder, etc.), and can remain highlighted until they read or otherwise appropriately interacted with the pending messages 200. Also, or in addition to, the application 300 can also be configured to use alert functionality of the device 12 (e.g. a general light indicator separate from the message 200 to indicate at least one message 200 is pending, visual indicator emphasizing the message 200 as compared to other non-emphasized messages 200 on the screen, auditory indicator, vibration indicator, etc.) as an OS alert/indicator of some sort to be shown every time a user gets a new message 200 that has not yet been interacted with by the user.

At the bottom of this page can be an Advertizing banner, which can appear on every page within the application 300.

In terms of inquiry messages 210, these message types 210 can include a Contact Your Pharmacist message 210 that provides for the user a “quick connect” method of contacting their “home” pharmacy store 15. When this option is selected a Contact Your Pharmacist screen is displayed on the client device 12 (e.g. as coordinated by a client resident health application 300 and/or a server application 300). The Contact Pharmacist screen can provide the user with a “quick call button” that will dial the home pharmacy 15 of user. The home pharmacy 15 phone number can be loaded into the application 300 based on the pharmacy store 15 that registered the user. The published hours of the Home Pharmacy could be included on this screen. Further, this contact screen could also contain a message for the user that all emergency should go to the hospital or call 911, as well as a message indicating that there is no cost for the call but normal cellular charges will apply. Accordingly, the Quick Call Button can be located on the screen (for telephone/email enabled devices 12) and provide the user to call/contact their home pharmacy 15 directly, such that following the conclusion of the call (e.g. telephone call, draft and send of email, etc.) the user is returned to the application 300 for access to other features as described herein.

Another inquiry message 210 can be a Contact TeleHealth Ontario message 210 (or other health service information provider) that provides for the user a “quick connect” method of contacting TeleHealth Ontario's Main Switchboard. When this option is selected the Contact TeleHealth Ontario screen is displayed on the client device 12. When this option is selected a Contact TeleHealth Ontario screen is displayed on the client device 12 (e.g. as coordinated by a client resident application 300 and/or a server application 300). The Contact TeleHealth Ontario screen can provide the user with a “quick call button” that will dial the health service information provider available to the user. The Contact TeleHealth Ontario phone number can be loaded into the application 300. The published hours of the Contact TeleHealth Ontario could be included on this screen. Further, this contact screen could also contain a message for the user that all emergency should go to the hospital or call 911, as well as a message indicating that there is no cost for the call but normal cellular charges will apply. Accordingly, the Quick Call Button can be located on the screen (for telephone/email enabled devices 12) and provide the user to call/contact their Contact TeleHealth Ontario directly, such that following the conclusion of the call (e.g. telephone call, draft and send of email, etc.) the user is returned to the application 300 for access to other features as described herein.

In view of the above, it is recognised that communications 210 can be communicated, for example between the client device 12 and the pharmacy 15 (e.g. via their computer systems including their server 16 and/or the pharmacy telephone).

In terms of pharmacy event messages 212, these message types 212 can include Clinic Days, Pharmacy Events, Med Check Days, and any other appointments that require scheduling for the user to attend (e.g. physically and/or remotely such as in store 15 visits, Webinars, telephone calls, or other real time events). For example, Clinic Days and Pharmacy Events messages 212 are sent to the user device 12 whenever their “Home Pharmacy” 15 (i.e. the pharmacy that registered the user) is holding a special event such as a Clinic Day (Diabetes Workshops, etc) or other Pharmacy events that are considered of particular interest to the user. This message 212 can be configured as informational only in nature and may or may not require a response message 212 from the user. In terms of Med Check Days, the users will receive a message 212 whenever their “Home Pharmacy” 15 is holding a Med Check day or clinic. This message 212 can inform the user of the event and will ask if they would like to book a time at the pharmacy 15 to have a med check. If the user selects the Yes option, they will be asked to book a time. The application 300 will check with the existing event schedule to confirm that the user selected time hasn't been taken by another user(s) and will notify the user if they need to select another time. The Med Check day message 212 can also be used as a message reminder in the main inbox of the user for the day of the event as well as to automatically (or otherwise prompt) the creation of a reminder in as a “Drug Reminder” function to alert the user of the event at the appropriate time. The appointment can also be loaded into the user's mobile device 12 calendar. In turn, the Pharmacist can log into their server console and see who has registered for specific events and the calendar for that day.

In view of the above, it is recognised that communications 212 can be would communicated, for example, between the client device 12 and the coordination server 14 that organizes the events on behalf of the pharmacy 15. In this case, the pharmacist of the pharmacy 15 would access an event calendar (i.e. in storage 17) that would be available either locally or remotely via the coordination server 14. It is also recognised that the pharmacist could send details of the events in a communication 212 to the coordination server 14 for subsequent coordination between the server 14 and the client devices 12 for registration for the events and/or could send the communication 212 directly to the user device 12, as desired.

As further described below, the use of condition data 9 by the server 14 and/or the server 16 is implemented in order to filter or otherwise streamline the type/amount/number/format/content of the communication(s) 212 to the user, such that only the communications 212 that are deemed to match the electronic personal health information data 9 of the user are communicated to the user over the communications network 11. In this manner, the number of communications 212 received by the user device 12 are reduced. For example, in the case where the electronic personal health information data 9 of the user does not include “pregnancy”, pregnancy and related infant care event communications 212 would be filtered out and not sent to the user, thus inhibiting communications 212 to the user that may be considered by the user as junk mail or otherwise bothersome communications for which the user has no desire or use to receive.

Accordingly, upon RSVP of any events or Meds Check or other communications 212, the date/time can be placed into the calendar of the device 12 as per operation of the application 300 (e.g. the calendar can be part of the application 300 or can be a calendar application separate from the application 300).

In terms of product/service information messages 214, these message types 214 can include view pharmacy flyer, search medication, drug reminders, refill requests, refill reminders, and others communications related to receiving or enquiring information about products and/or services offered by the pharmacy store 15 that are complimentary or otherwise available for purchase by the user (i.e. that user using the client device 12, for example. and registered with the pharmacy store 15). The communications 212 are displayable (or otherwise created) on the user interface 104 of the client device 12, via the application 300.

An example of communication 214 of View Pharmacy Flyer can contain an electronic copy of the Home Pharmacy's 15 Flyer (if applicable) that provides information of products/services available at the pharmacy store 15, as displayable on the user interface 104 of the client device 12. When this option is selected the View Pharmacy Flyer page is launched. This option may not be available if the pharmacy 15 has not uploaded an electronic image/copy of their flyer into the system. For example, the flyer can be a jpg or other image of their weekly flyer that can be interactive, not interactive, or a combination thereof. Each page of the flyer can contain images of products/services available via the pharmacy store 15 and the user can leaf (or otherwise interact) through the different pages via the application 300. Further, optionally at the bottom of each page (or other region of the flyer material) is an Advertizing banner, as further described below. For example, this banner can appear on every (or otherwise selected) page/screen that is displayed by the application 300 on the user interface 104 of the client device 12. Further, the user is able to navigate through the flyer on the user interface 104 by selecting the Next Page or Previous Page buttons on the screen. The user can also zoom-in/zoom-out in to see specific details of the Flyer.

An example of communication 214 of Search Medication is where selection of this feature from the application 300 provides for the user to search for prescription, over the counter drug, and natural health products information (if available). When this option is selected the Search Medication page is displayed on the user interface 104 of the client device 12 and provides for interaction of search and display functions with the user, such that the user can search and display medication information that is either stored locally on the device 12 and/or stored remotely off the device 12. The Search Medication selection provides the user a method of searching for prescription and over the counter drug information. The user can search for a drug by name or by DIN or by category (eg cold/Flu, decongestants, heart disease, etc). Previously unsearched drug information may not be stored locally. The application 300 can also facilitate the sending of a request 214 to the server 14,16 which will send the drug information down to the device 12. The information populated on this display page can be similar (e.g. format and structure) to the Drug Detail page, further described below. This page can contain all the specifics about the drug the user has searched, including a detailed description, typical dosage, side effects, a picture, and/or common interactions. Other options for the application 300 operation include: the last specified number (e.g. 5) previously searched drugs can remain stored on the device 12 (e.g. Search Medication History), such that the user can select any of these drugs and the drug details will be shown.

An example of communication 214 of Drug Reminder selection of this feature from the application 300 provides for the user to set a reminder to take a specific drug defined in their User Medical Profile 50, further discussed below. When this option is selected a Drug Reminder page can be launched via the application 300. An example of communication 214 of Refill Request selection of this feature from the application 300 provides for the users to request a refill on a specific drug in their User Medical Profile 50. When this option is selected the Refill Request page is launched via the application 300.

For example, for Refill Reminder communications 214, the users can receive a message 214 (displayed or otherwise indicated on the user interface 104 of the device 12) indicating that they have a refill due, including the drug name. The user can have the option of accepting the Refill and then indicating if they would like it delivered or if they will pick-it up, such that the actual refilling of the drug is performed or otherwise coordinated by the pharmacy store 15. The user can also “snooze” the reminder and the application 300 can remind him (e.g. send or otherwise trigger an alert via the device 12, for example a beeping sound, a flashing light, an email marked urgent or otherwise emphasized from other emails/.messages listed on the user interface 104) again in a specified/configured X time). The user can select how long they can snooze it for (e.g. 2 hours, 2 days, 30 days). The user can have a dismiss option after a specified number of delay/snooze selections for the reminder (e.g. after the third time they have snoozed the reminder).

The application 300 will also indicate (e.g. sent from the coordination server 14) a message 214 for a Refill Expiry that is approaching. As refills reach their specified reminder mark (e.g. 10 month mark where they expire after 12 months) a message 214 can be indicated to the user informing them that their refill is expiring soon and asking them if they need a refill. The user has the option of accepting via the application 300 the Refill and then indicating via the application 300 if they would like it delivered or if they will pick-it up. If a refill is requested 214, including a delivery, this information is passed 214 back to the in-store Pharmacy server 15 to be placed in their work queue. If delivery is selected, the user can be asked 214 via the application 300 if they want to use their default settings for delivery (e.g. as soon as it is available, anytime after 6 pm, etc). This can be asked the first time a user selects delivery and can be stored for future reference and use by the application 300 for subsequent refill reminders and/or refill orders and deliveries.

An example of communication 214 of My Prescriptions Page selection of this feature from the application 300 provides for the user to have access to (e.g. displayed on the user interface 104) page(s)/screen(s) containing a listing of all prescription drugs that the user is currently on (in the active list) as well as an option to view historical drugs that the patient has been on in the past (under drug history). It is recognised that this drug information can be contained in the electronic personal health information data 9 and/or other areas of the user medical profile 50, as further discussed below This page/screen of the application 300 also allows users to select a specific drug and access drug detail to get more information about that particular drug including description, typical dosage, side effects, and common interactions. Active drugs (in the active list) can be calculated by the application 300 based on the number of pills and the prescribed dosage (e.g. 30 day prescription would “expire” following 30 days). When a drug “expires”, the user can be asked 214 if they are still taking the drug and if they respond “Yes” it can be kept by the application 300 in the Active list for an additional 5 days, for example, before asking them again.

In terms of My Prescriptions Actions (e.g. My Prescriptions “Active Drug Inbox display) of the application 300, all patient specific drug information from the Home Pharmacy's systems 16 can be populated within the Active inbox. The drug can appear on the top line and a short description of the drug can appear under it. The application 300 can be configured to check for any updates in the Pharmacy's home server 16 when it is loaded. In terms of an Add Drugs button within the “Active Drug Inbox” of the application 300, the user has the ability to add a drug to the list, but for example only OVER THE COUNTER drugs and natural health products (if available). This can be be specifically stated to the user when they select the “Add Drug” button. The user can either enter the DIN or the name of the drug. Updates to the drug content are populated or otherwise reflected in the user medical profile 50, either automatically by the application 300 and/or manually by the pharmacist (via the server 16) in consultation with the user, as further described below.

In terms of Drug Detail, a Drug detail page/screen of the application 300 can contain all the specifics about the drug the user is taking, including a detailed description, typical dosage, side effects, a picture, and common interactions. In terms of a My Prescriptions “Historical Drug Inbox” page/screen of the application 300, the Historical Drug Inbox can contain all drugs within the Home Pharmacy's server 16 that do not fall within the “Active” status of drugs, for example. In any event, it is recognised that the drug information described above can be represented in the customer medical profile 50, as discussed below, for subsequent usage by the coordination server 14 in filtering messages 200 appropriate to the user.

The coordination server 14 has access to available medical information 58 (see FIG. 3) that may be of interest to any number of users 57 of the environment 10. As discussed below, it is recognized that the content of the available medical information 58 is of a greater health information breadth than would otherwise be of interest to any particular user 57. Accordingly, in order to effectively search and provide pertinent information (e.g. the customized health related information 59) as a subset of the available medical information 58 to the user 57, the coordination server 14 uses the electronic personal health information data 9 to configure filters 336 (as used by the generation module 338) to obtain these desired subset(s) from the available medical information 58 for communicating to the user 57 as the customized health related information 59. The customized health related information 59 is provided to the device 12 by the coordination server 14 using the communications 216. It is recognized that the communications 216 can also contain advertizing data 55 inserted into the subset of the available medical information 58 provided in the communications 216 as the customized health related information 59.

The advertizing data 55 can also be referred to as advertising information provided by third parties 250 that are supplying the products/services to the pharmacy store 15 for sale or otherwise made available to the user 57, as desired (see FIG. 4). The third parties 250 can be manufacturers and/or distributors of the products/services available for purchase and/or access by the user 57 in association with the pharmacy store 15. Examples are a distributor for vitamins as the third party 250 and the product is vitamins on the pharmacy store 15 shelf, such that the advertizing data 55 is provided to the coordination server 14 by the third party 250 and appropriate financial compensation is provided to the owner/operator of the coordination server 14 in exchange for distributing the advertizing data 55 in the messages 216 to the users 57, on behalf of the third party 250. Generation of the message 216 can be performed by a generation module 338 of the coordination server 14, as further described below.

It is recognised that the different messages 212,214,216 are addressed to the particular user computing device 12 that is associated with the user having one or more defined medical conditions, also referred to as disease(s), defined by electronic personal health information data 9, as further described below. It is the definitions 8 contained in the electronic personal health information data 9 that are used to facilitate what data content 9,55 is included in the messages 212,214,216, as further described below.

In addition to the above communications 200, there are also registration messages 218 that are communicated to the coordination server 14, e.g. by the pharmacy server 16, to initiate registration of a particular user with the pharmacy customer management environment 10 as facilitated by the coordination server 14. The registration message 218 results in the application 300 being made available by the coordination server 14 to the computing device 12 for provisioning on the device. A registration module 332 (of the coordination server 14—see FIG. 6) can be configured for receiving electronic registration information of the user including user identification data of the individual user 57 and pharmacy store identification data of the particular pharmacy store 15 at which the user is registered. As discussed above, registration of the user includes the pharmacy store identification data. This pharmacy store identification data can include definition data for a single physical pharmacy store frequented by the user, can be defined as a group of physical pharmacy stores frequented by the user, and/or can be defined as any of the physical pharmacy stores for a selected pharmacy brand (e.g. the pharmacy store 15 can be all stores associated with the CVS™ pharmacy brand). In terms of a national chain of pharmacy stores, the definition data of the pharmacy store 15 can be defined as one or more physical stores that are associated with a selected geographical region (e.g. state, province, city, neighbourhood, etc.) or within a selected distance from the user's location (e.g. static home address, dynamic GPS location of the user's device 12, specified user location, etc.). It is recognised that in the case of dynamic user location as one of the parameter's for registration by the user with the pharmacy store 15, the communications 200 from the user device 12 would contain the user location data for use by the coordination server 14 as one of the filter criteria in generating and sending the customized health related information 59. For example, the communication module 340, the confirmation module 342, the registration module 332, and/or the user module 330 can be used by the coordination server 14 to obtain the real-time user location for use in generating the customized health related information 59.

The coordination server 14 has access to available medical information 58 (see FIG. 3) that may be of interest to any number of users 57 of the environment 10. As discussed below, it is recognized that the content of the available medical information 58 is of a greater health information breadth than would otherwise be of interest to any particular user 57. Accordingly, in order to effectively search and provide pertinent information (e.g. the customized health related information 59) as a subset of the available medical information 58 to the user 57, the coordination server 14 uses the electronic personal health information data 9 to configure filters 336 (as used by the generation module 338) to obtain these desired subset(s) from the available medical information 58 for communicating to the user 57 as the customized health related information 59.

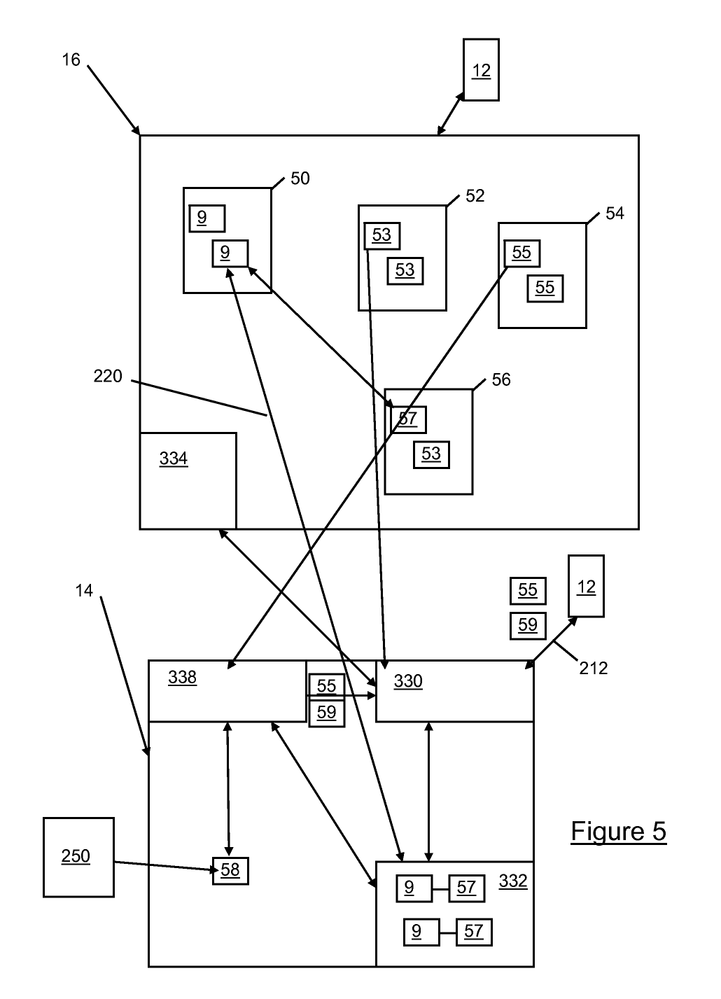

Accordingly, it is recognised that medical information content 59 is obtained as an information subset from a plurality of medical information 58 made available (e.g. remotely via the network 11) or otherwise stored locally in storage 17. The medical information 58 is defined to contain at least some medical and/or health related information/knowledge that is desired by the users for display on their devices 12. As further described below, this medical information content 59 is matched to the respective registered customers 57 (see FIG. 5), based on their electronic personal health information data 9 made available to the coordination server 14, and transmitted via messages 216 to the devices 12 for processing and display by the application 300.

One example of the available medical information 58 is a Healthy Living Guide made available to the user 57 by the application 300 of the coordination server 14. The Healthy Living Guide of the application 300 can contain healthy living reading material for the user 57, with recommended reading articles (e.g. the customized health related information 59) based on the electronic personal health information data 9 of the user 57, e.g. users with insulin prescriptions will have articles about living with Diabetes as suggested reading. When this option is selected the Healthy Living Guide Main Menu page can be launched. For example, there can be imbedded advertising data 55 within the content sections that are read by the user 57. The advertizing data 55 can include underlined key words, for example, with links to third parties 250 who provide those types of products (yogurt is underlined and links to Yoplait).

The user will also have the ability to search the available medical information 58 for reading information in addition to the recommended reading that is provided to him based on their electronic personal health information data 9. In terms of Healthy Living Guide Actions (e.g. based on the prescriptions of the user in the electronic personal health information 9) provided via the communication messages 216 could be recommended (as the customized health related information 59) reading to the user based on the disease/sickness that the user has. For example, users with insulin prescriptions (defined in the electronic personal health information data 9) will have articles about living with Diabetes as suggested reading. Other topics that could be covered include: High Blood Pressure, Cholesterol, Hypertension, HIV, etc, for example, based on corresponding compatible definitions in the electronic personal health information data 9. It is recognised that the electronic personal health information data 9 can linking of the drugs someone is on with the disease/medical condition they have (e.g. linking insulin to diabetes).

In terms of embedded advertising, as discussed above, each of the customized health related information 59 (e.g. HLG articles) can include helpful information and imbedded advertising data 55 within the content sections that are read. The advertizing data 55 can consist of underlined key words with links to third parties 250 who provide those types of products. When a link is clicked on by the user, a secondary window can be opened and the navigation can be done in that window to direct the user to further details concerning the products related to the advertising data 55. Further, it is recognised that the application 300 can provide for a search function of the available medical information 58, such that the search selection allows the user 57 a method of searching for any HLG content available based on a set of search parameters including word search, date, etc, for example. Further, users can have the ability to share information they find within the available medical information 58 on facebook, twitter, linkedin, etc, for example.

The electronic personal health information 9 is used by the environment 10 to facilitate the communication of customized health related information 59 in the communications 216 (for example), for example using filters 336 by the generation module 338 (see FIG. 6) to filter available health related information 58 using the electronic personal health information 9 to generate the customized health related information 59 suitable for communication to the device 12 for subsequent presentation to the user 57 (see FIG. 4). For example, the customized health related information 59 can include electronic data containing explanatory information related to at least one of a specified disease or a health condition submitted to the coordination server 14 as a request communication 200. For example, the request communication 200 can contain a query for further information pertaining to at least one of a specified disease or a health condition, such that this requested information is available in the available health related information 58. It is also recognised that the customized health related information 59 can include lifestyle considerations for the user to facilitate in management of the at least one of the specified disease or the health condition specified in the communication request 200.

It is also recognised that the customized health related information 59 can include electronic data for product information data 55 of the pharmacy store 15 for one or more suggested products compatible with at least one of the specified disease or the health condition specified in the communication request 200. It is also recognised that the customized health related information 59 can contain electronic event information pertaining to one or more scheduled events associated with the pharmacy store 15, such that the one or more scheduled events are compatible with the electronic personal health information 9 as decided by the generation module 338 in using the filters 336. It is recognised that the one or more scheduled events can include a details of a scheduled clinic at a remote location associated with the pharmacy store 15 and/or details of a scheduled clinic at the pharmacy store 15 itself, for example.

The electronic personal health information 9 is used by the environment 10 to provide one or more disease definition(s) 8 of the user that is/are abnormal condition(s) affecting the body of the user. A disease is often construed to be a medical condition (e.g. a medical condition definition 8) associated with specific symptoms and signs. The disease may be caused by external factors, such as infectious disease, or it may be caused by internal dysfunctions, such as autoimmune diseases. Ecologically, disease is defined as maladjustment of the customer body with environment. For example, in humans, “disease” is often used more broadly to refer to any condition that causes pain, dysfunction, distress, social problems, and/or death to the person afflicted, or similar problems for those in contact with the person. In this broader sense, it sometimes includes injuries, disabilities, disorders, syndromes, infections. Isolated symptoms, deviant behaviours, and atypical variations of structure and function, while in other contexts and for other purposes these may be considered distinguishable categories. A diseased body is quite often not only because of some dysfunction of a particular organ but can also be because of a state of mind of the affected person who is not at ease with a particular state of its body. For example, there can be different types of disease, such as but not limited to: pathogenic disease, deficiency disease, hereditary disease, and physiological disease.

Further, it is recognised that a medical condition is a broad term that includes all diseases and disorders, but can include [injuries] and normal health situations, such as pregnancy, that might affect a person's health, benefit from medical assistance, or have implications for medical treatments. The term medical condition can also generally include mental illnesses. It is also recognised that the electronic personal health information 9 can also include medical prescription information and specific drug definitions 8 that can include names of drugs/medication (e.g. prescription and/or non-prescription medication/drugs) that the user is currently prescribed or has otherwise obtained, or is known to be taking by the pharmacist of the users preferred pharmacy store 15. It is recognised that the drug definitions 8 can be used in place of or to otherwise facilitate the definition(s) 8 of the condition definitions 8. In other words, the drugs/medication that the user is taking can be used as information to help define the particular diseases/conditions of the user causing them to take the drugs/medication.

As further described below, it is recognised that the electronic personal health information 9 is confirmed 220 by the pharmacist (or other person associated with the preferred pharmacy store 15) of the user that has direct knowledge of the drugs/medication and/or medical condition of the user. This confirmation message 218 is communicated to the pharmacy coordination server 14, in order to help configure the subsequent communications 200 (and their content) between the servers 14,16 and the computing device 12, as further described below.

It is also recognised that the confirmation 220 of the electronic personal health information 9 is used to realize that the coordination server 14 has a correct definition of the user's health information, in order to facilitate the customization of the general health related information 58 by the generation module 338. For example, confirmation 220 of the electronic personal health information 9 can be received from the pharmacy server 16 as a response to a confirmation request directed from the coordination server 14 to the pharmacy server 16. In other words, confirmation 220 of the electronic personal health information 9 can be sent by the pharmacy server 16 as a response to a confirmation request directed from the coordination server 14 to the pharmacy server 16. Alternatively, or in addition to, confirmation 220 of the electronic personal health information 9 can be sent by the computing device 12 as a response to a confirmation request directed from the coordination server 14 to the computing device 12.

Further, it is recognised that updates (e.g. at least one of addition of new information, deletion of current information, amendment of current information) to the electronic personal health information 9 can be provided to the coordination server 14 by the computing device 12, by the pharmacy server 16, or a combination thereof. For example, electronic update data to the electronic personal health information 9 can include update information to at least one of the user medication information and the associated user condition information of the definitions 8. In terms of the pharmacy server 16 communicating the update information, a health care professional of the pharmacy store 15 can be responsible for sending the update information in an update communication message 200 to the coordination server 14, based on changes in the electronic personal health information 9 as known to the health care professional. The health care professional can be for example a pharmacist employed with the pharmacy store 15; a person associated with the pharmacist and employed at the pharmacy store 15; and/or a person associated with the pharmacist and employed at a location remote from the pharmacy store 15.

As discussed above, one aspect of the electronic personal health information 9 can be user geographic location. The coordination server 14 could use the user geographic location associated with the electronic personal health information 9 of the user in generating the customized health related information 59. Further, the electronic personal health information 9 can also include one or more group parameter(s) used to assign the user to one or more defined user groups. The coordination server 14 can use the user group parameters to facilitate communications 200 with all users belonging to the specified group. For example, the group parameter can be representative of one or more specific drugs and/or medication (e.g. prescribed pain medication) that the user is taking, can be representative of one or more specified pharmacy stores 15 (e.g. the pharmacy store 15 that the user is registered with), and/or can be representative of one or more medical conditions (e.g. diabetes, high blood pressure, low sodium diet, etc.). The coordination server 14 could use the group parameter in the electronic personal health information 9 of the user in generating the customized health related information 59.

Referring to FIG. 5, shown is an example pharmacy server 16 configured for communication with the pharmacy coordination server 14 and/or the computing device 12 over the communications network 11. The pharmacy server 16 has access to a customer medical profile 50, a pharmacy event profile 52, a pharmacy product/service profile 54, and a customer registration database 56, any of which can be stored in the storage 17 (see FIG. 1) locally and/or be available to the server 16 in remote storage (not shown) over the communications network 11.

The customer medical profile 50 of each customer contains the electronic personal health information 9, including historical medication/drugs used by the customer as well as medication/drugs currently being used by the customer. It is recognised that one purpose of the customer medical profile 50 is to keep track of the present and historical medical interaction between the user and the pharmacist of the user preferred pharmacy store 15. For example, this can include present dispensed medications, refill periods for medication, and historically dispensed medications by the pharmacist to the user. It is recognised that the present medications used by the user are representative of at least some of the one or more diseases/medical conditions experienced by the user. The entire medical profile or at least a portion of the medical profile (e.g. the electronic personal health information 9) is confirmed 220 to the coordination server 14 by the pharmacy server 16, for example, for each user 57 registered (in the customer database 56) with the pharmacy store 15 and having accessed the application 300, as further described below. The disease/condition definitions 8 contained in the electronic personal health information 9 can be used by the coordination server 14 to customize the content of the health information messages 216, and optionally event messages 212, such that the content is pertinent to the events, products/services, and/or health information relevant to the disease/condition definitions 8 for the respective user. For example, if the registered user 57 was defined by the electronic personal health information 9 to have arthritis caused by old age, the events, products/services, and/or health information content of the messages 212,216 would be related to joint pain relief, age appropriate activities and products, etc. Excluded from the events, products/services, and/or health information content of the messages 212,216 would be data not related to the electronic personal health information 9 of the registered user 57. In the case of arthritis caused by old age, pregnancy products, newborn products, hospital information, newborn feeding/nutrition information and related pharmacy events would be excluded from the messages 212,216 based on the electronic personal health information 9 of the registered user 57.

In view of the above, it is recognised that the electronic personal health information 9 can be confirmed 220 to the coordination server 14 at the time of registration of the user 57 with the coordination server 14 (e.g. provided by the pharmacy server 16 to the coordination server 14 along with user 57 registration information facilitating access to the application 300 by the device 12), can be confirmed after registration of the user 57 with the coordination server 14 (e.g. provided by the pharmacy server 16 to the coordination server 14 after the user 57 has accessed the application 300 by the device 12—for example in response to user 57 registration information being received by the coordination server 14), can be confirmed at periodic update intervals to the coordination server 14 as the electronic personal health information 9 is modified/updated by the pharmacist in response to changing the medical condition of the registered user 57 over time, or a combination thereof. It is recognised that the confirmation message 220 can be a synchronous and/or asynchronous communication 200 received by the coordination server 14 on behalf of the registered user 57 (e.g. communicated 200 via the customer device 12 or directly from the pharmacy server 16). In other words, it is the user themselves that can confirm the electronic personal health information 9 and/or updates thereto.

The coordination server 14 can have a registration module 332 for storing the associations of electronic personal health information 9 and registered users 57 for each of the pharmacy stores 15, in order to facilitate the configuration/customization of communications 200 (e.g. type of message, content of message, delivery timing of message, etc.) between the coordination server 14 and the respective users 57.

The pharmacy event profile 52 contains detailed information 53 (e.g. dates, times, event description, event location such as the pharmacy store 15) of events organized by the pharmacy store 15 that may be of interest to one or more of their users 57, in particular those events that are relevant to the electronic personal health information 9 of the user 57.

In terms of clinic days and pharmacy events, users 57 can receive a message 212 whenever their “Home Pharmacy” (i.e. the pharmacy 15 that registered the user 57 with the coordination server 14) is holding a special event such as a Clinic Day (Diabetes Workshops, etc) or other Pharmacy events, for example, as processed and displayed to the user 57 on their device 12 by the application 300. This message 212 can be informational in nature and may not require a response from the user 57.

Further, the users 57 can also receive a message 212 whenever their “Home Pharmacy” is holding a Med Check day or clinic, as processed and displayed to the user 57 on their device 12 by the application 300. This can inform the users 57 of the event and will ask if they would like to book a time at the pharmacy 15 to have a med check. If the user 57 selects the Yes option, for example as provide by the application 300, they can be asked to book a time. The application 300 can check with the server 14,16 to ensure that that time hasn't been taken by another user 57 and can notify the user 57 if they need to select another time. The Med Check day feature of the application 300 can also generate a message reminder in the main inbox the day of the event as well as automatically create a reminder in the “Drug Reminder” function to alert the user 57 of the event at the appropriate time. The appointment can also be loaded into the user's 57 calendar resident on the device 12, including alerts indicated (e.g. visual indicator such as a flag, a flashing light, vibration, etc.) on the device 12 indicating that a communication message 212 is unread.

In addition to the above, the Pharmacist can log into their server 16 console via a communications module 334 with an event module (e.g. a subset of the generation module 338, a separate module to the generation module 338, etc.) of the coordination server 14 and see who has registered for specific events and the calendar for that day.

It is recognised that the coordination server 14 can be made aware of all event information 53 by the pharmacy server 16 (i.e. for all scheduled clinics/events to be held at the preferred pharmacy store 15) and the coordination server 14 by way of the event module can select or otherwise filter those event information 53 relevant to each respective user 57 based in their corresponding electronic personal health information 9 known by the coordination server 14. In other words, the event module matches those event information 53 with the corresponding condition definitions 8 of each relevant user 57 and the configures the corresponding content of the message 212 to pertain only to those events (or at least partially restricted from the full set of available events information 53). In other words, the event module can compare with the registration module 332 to match those events information 53 pertinent to the condition data of each registered user 57. Matched electronic personal health information 9 with event information 53 means that the matching user(s) 57 would receive message(s) 212 pertaining to the event information 53, while those user(s) 57 having unmatched electronic personal health information 9 (with event information 53) would not receive message(s) 212 pertaining to the event information 53. In this manner, the messages 212 and respective content can be customized by the coordination server 14 based on the electronic personal health information 9 of each of the users 57.

One example matching method performed by the coordination server 14 (e.g. by the event module) is where each event information 53 (e.g. specifying the date, time, event description, event location, etc. of an event) also contains one or more condition IDs that correspond with one or more predefined condition IDs that are assigned to each condition and/or drug definition 8 contained in the electronic personal health information 9 of each customer 57. For example, an event schedule 53 of a pregnancy clinic with ID=“Preg” and a high blood pressure clinic with ID=“Blood” would be compared by the event module against all electronic personal health information 9 of the users 57 (held by the registration module 332) to find matching IDs of “Preg” and/or “Blood”. One example case could be where a first registered user 57 has a medical condition including pregnancy and high blood pressure (i.e. has the IDs “Preg” and “Blood” in their electronic personal health information 9) while a second registered user 57 has a medical condition including on arthritis (i.e. has the ID “Arthritic” but does not have the IDs “Preg” and “Blood” in their electronic personal health information 9). In this case, the first registered user would receive a configured event message 212 informing them of the event information 53 pertaining to both the pregnancy clinic and the blood pressure clinic while the second registered user would not receive any configured event messages 212, as not arthritis clinics have yet been scheduled.

Referring again to FIG. 5, the pharmacy server 16 can also have a products/services profile 54 that includes a product/service information 55 (e.g. advertizing data such as product/service name, product/service price, product/service description, product/service availability in stock, etc.) for each product/service that is available or otherwise for sale at the pharmacy store 15 and/or otherwise available for order through the pharmacy store 15. The product/service information 55 can be incorporated into the form of an electronic flyer and/or a hyperlink to the product/service information 55 available on a Website hosted or otherwise associated with the pharmacy server 16. The product/service information 55 can also optionally contain the condition IDs to provide for filtered matching/searching of the product/service information 55 with respect to the electronic personal health information 9 of each user 57.

For example, the pharmacy server 16 can make the product/service information 55 available to the coordination server 14 (e.g. to a product module 336) so that the respective pertinent product/service information 55 can be made available to the pertinent devices 12 via messages 212 generated by the product module 336 for those users 57 having conditional data 9 matching the pertinent product/service information 55 (e.g. using matching IDs of the conditional definitions 8 and the individual products/services of the product/service information 55). Alternatively, or in addition to, the product/service information 55 can be made available to the users 57 independently of their conditional data 9 (i.e. matching between the product/service information 55 and the conditional definitions 8 is not done by the product module 336 and therefore each user 57 gets the full set of product/service information 55 provided by the pharmacy server 16). Alternatively, the user can get both matched product/service information 55 and unmatched product/service information 55 in the messages 214, as desired.

In view of the above, it is recognised that in economics, economic output is divided into goods and services. When an economic activity yields a valuable or useful thing, it can be known as production output of the totality of products (e.g. goods or services) in an economy that the pharmacy store 15 makes available for use by the users 57. Products as goods can range from a simple safety pin, food, clothing, pharmacy services to the provision of prescription and non-prescription medications. Products as services are the performance of any duties or work for another (e.g. helpful or professional activity) and can be used to define intangible specialized economic activities such as but not limited to: providing access to specific information; any defined pharmacist services; medical products; consumer products; services provided by other employees or associates of the pharmacy store 15; and general medical advice. The pharmacy store 15 providing the products can be a businessperson/individual engaged in wholesale/retail trade, an organization, an administration, and/or a business that sells, administers, maintains, charges for or otherwise makes available product(s) that are desirable by the users 57. Accordingly, the pharmacy store 15 can be one person, or an association of persons, for the purpose of carrying on some enterprise or business; a corporation; a firm; etc. Further, it is recognised that the provision of products/services information 55 related to the products and/or services of the pharmacy store 15 can be applied to pharmacy store 15 activities not related to specific product(s), for example activities such as customer service, community activities, and/or sponsorships. These general activities of the pharmacy store 15 are also considered as part of the definition of pharmacy store 15 products.

It will be understood that for the purposes hereof, the user 57 may be any user (i.e. first hand product experience) of pharmacy store 15 products (e.g. goods and/or services). For example, the user 57 may be an individual who purchases pharmacy store 15 goods and/or services for personal use, and not for resale or for use in the production of other goods and/or services for resale. Or the user 57 may be a business purchasing pharmacy store 15 goods and/or services for use in its business, i.e., for resale or for use in the production of other goods and/or services for resale. Further, it is recognised that user 57 may not purchase the goods and/or services. For example, the user 57 may have acquired the goods and/or services pursuant to a free trial offered by the pharmacy store 15. For example, the user 57 can be a person who desires the professional products and/or services (e.g. obtaining of prescription and non-prescription drugs) of a pharmacist as well as any other consumer products and/or services that may not be directly related to pharmacist services/products (e.g. chips, soft drinks and cosmetics).

Any business or organization can be called an enterprise, while consumers are individuals or households that purchase and use goods and services generated within the economy. It is recognised that both enterprises and consumers can be included in the definition of users 57, as desired.

Accordingly, it is recognised that the user 57 can be a private individual desiring information/purchase (e.g. B2C) of the pharmacy store 15 products or can be a person, or an association of persons, for the purpose of carrying on some enterprise or business (e.g. a corporation, a firm, etc.) that desires information/purchase (e.g. B2B) of the pharmacy store 15 products. It is recognised that the user 57 can communicate with the pharmacy store 15 as a potential purchaser (i.e. window shopping) or as an intended purchaser of the pharmacy store 15 products, as desired.

Referring to FIG. 6, shown is an example configuration of the coordination server 14 for facilitating the presentation of health related information over the electronic communication network 11 to a plurality of users 57, such that each of the plurality of users 57 is registered with a particular pharmacy store 15 (see FIG. 1). As discussed above, the coordination server 14 can include a registration module 332 configured for receiving electronic registration information of the user 57 (for example from the pharmacy server 16) including user identification data and pharmacy store identification data of the particular pharmacy store 15 at which the user 57 is registered. The coordination server 14 can also have a user module 330 configured for receiving or otherwise accessing (e.g. from the data storage 17) electronic personal health information 9 of the user 57 including current user medication information and associated user condition information. It is recognised that updates to the electronic personal health information 9 can also be processed or otherwise accessed by the user module 330.

A confirmation module 342 is configured for confirming 220 the accuracy of the electronic personal health information 9 with at least one of a health care professional of the pharmacy store 15 or the user 57, as described above. For example, the user 57 could answer a series of questions communicated 200 (see FIG. 1) to the device 12 by the coordination server 14, such that the responses to the questions could be communicated 220 back to the coordination server 14 as updates to the electronic personal health information 9. In this case, the coordination server 14 could seek confirmation 220 (e.g. as communications 200) with the pharmacy server 16 (see FIG. 3) of the updates as provided by the user 57 to the electronic personal health information 9. Alternatively, updates to the electronic personal health information 9 could be communicated 200 to the coordination server 14 by the pharmacy server 16 (e.g. in the event of a medication change by the pharmacist for the user 57). In this case, the coordination server 14 could seek confirmation 220 (e.g. as communications 200) with the device 12 of the updates, as provided by the pharmacy server 16 to the electronic personal health information 9.

A further example of confirmation 220 is where the coordination server 14 updates or otherwise amends the electronic personal health information 9 based on analysis of the content. For example, the confirmation module 342 (or any other suitable module) could be configured to analyze the medication definitions of the electronic personal health information 9 and determine a representative medical condition or list of medical conditions that are compatible with the medication definitions. The updated content (e.g. determined representative medical condition(s)) could be communicated to the user device 12 and the user asked to confirm 220 the updated content (e.g. representative medical condition(s)). Upon receipt of confirmation 220, the coordination server 14 would then use the updated/electronic personal health information 9, as confirmed by the user, in subsequent generation of the customized health related information 59.

The coordination server 14 can also have a generation module 338 configured for generating the customized health related information 59 for the user 57 based on the confirmed electronic personal health information 9, for example using filters 336 as configured by the confirmed electronic personal health information 9 for the particular user 57. For example, the generation module 338 configured with the product filter 336 for inhibiting the inclusion (in the customized health related information 59) of certain advertizing data 55 (pertaining to certain products) considered incompatible with the confirmed electronic personal health information 9. Alternatively, the generation module 338 could be configured with the product filter 336 for promoting the inclusion (in the customized health related information 59) of certain advertizing data 55 (pertaining to certain products) considered compatible with the confirmed electronic personal health information 9. It is recognised that the filters 336 employed by the generation module 338 can be configured for each user 57 based on their respective electronic personal health information 9.

The coordination server 14 can also have a communication module 340 configured for receiving an electronic request communication 200 from the user for health related information and for sending an electronic response communication 200 including the customized health related information 59 (optionally including the deemed compatible advertizing data 55).

In the case of the application 300 on the device 12 being the health application 300, the coordination server 14 can also have an application module 334 configured for sending the health application 300 over the electronic communication network 11 to the communication device 12 of the user 57, e.g. via the communications 200, such that the health application 300 is configured for provisioning on the communication device 12 for configuring the communication device 12 for communication with the coordination server 14. For example, the health application 300 can be customized (e.g. concerning functionality and/or formatting) for the user 57 based on the electronic registration information. Further, the health application 300 can be configured for communication with the communication module 340 for sending the electronic request communications 200 and receiving the electronic response communications 200, configured for communication with the user module 330 for sending the electronic personal health information 9, and configured for communication with the user module 330 for sending electronic update data to the electronic personal health information 9, as well as confirmations 220 as discussed above.

In view of the above descriptions of storage 17 for the servers 14,16, the storage 17 can be configured as keeping the stored data (e.g. profiles 50,52,54,56, health information 58,59) in order and the principal (or only) operations on the stored data are the addition of and removal of the stored data from the storage 17 (e.g. FIFO, FIAO, etc.). For example, the storage 17 can be a linear data structure for containing and subsequent accessing of the stored data and/or can be a non-linear data structure for containing and subsequent accessing of the stored data.

Further, the storage 17 receives various entities such as data that are stored and held to be processed later. In these contexts, the storage 17 can perform the function of a buffer, which is a region of memory used to temporarily hold data while it is being moved from one place to another (i.e. between the network server 14,16 to the network device 12). Typically, the data is stored in the memory when moving the data between processes within/between one or more computers. It is recognised that the storage 17 can be implemented in hardware, software, or a combination thereof. The storage 17 is used in the network system 10 when there is a difference between the rate/time at which data is received and the rate/time at which the data can be processed (e.g. ultimately by the network resource server 14,16 and/or device 12).

Further, it will be understood by a person skilled in the art that the memory/storage 17 described herein is the place where data can be held in an electromagnetic or optical form for access by the computer processors/modules. There can be two general usages: first, memory is frequently used to mean the devices and data connected to the computer through input/output operations such as hard disk and tape systems and other forms of storage not including computer memory and other in-computer storage. Second, in a more formal usage, memory/storage 17 has been divided into: (1) primary storage, which holds data in memory (sometimes called random access memory or RAM) and other “built-in” devices such as the processor's L1 cache, and (2) secondary storage, which holds data on hard disks, tapes, and other devices requiring input/output operations. Primary storage can be faster to access than secondary storage because of the proximity of the storage to the processor or because of the nature of the storage devices. On the other hand, secondary storage can hold much more data than primary storage. In addition to RAM, primary storage includes read-only memory (ROM) and L1 and L2 cache memory. In addition to hard disks, secondary storage includes a range of device types and technologies, including diskettes, Zip drives, redundant array of independent disks (RAID) systems, and holographic storage. Devices that hold storage are collectively known as storage media.

A database is one embodiment of memory 17 as a collection of information that is organized so that it can easily be accessed, managed, and updated. In one view, databases can be classified according to types of content: bibliographic, full-text, numeric, and images. In computing, databases are sometimes classified according to their organizational approach. The most prevalent approach is the relational database, a tabular database in which data is defined so that it can be reorganized and accessed in a number of different ways. A distributed database is one that can be dispersed or replicated among different points in a network. An object-oriented programming database is one that is congruent with the data defined in object classes and subclasses. Computer databases typically contain aggregations of data records or files, such as sales transactions, product catalogs and inventories, and customer profiles. Typically, a database manager provides users the capabilities of controlling read/write access, specifying report generation, and analyzing usage. Databases and database managers are prevalent in large mainframe systems, but are also present in smaller distributed workstation and mid-range systems such as the AS/400 and on personal computers. SQL (Structured Query Language) is a standard language for making interactive queries from and updating a database such as IBM's DB2, Microsoft's Access, and database products from Oracle, Sybase, and Computer Associates.

Memory/storage 17 can also be defined as an electronic holding place for instructions and data that the computer's microprocessor can reach quickly. When the computer is in normal operation, its memory usually contains the main parts of the operating system and some or all of the application programs and related data that are being used. Memory is often used as a shorter synonym for random access memory (RAM). This kind of memory is located on one or more microchips that are physically close to the microprocessor in the computer.

In terms of a server, it is recognised that the server 14,16 can be configured as hardware, software, or typically a combination of both hardware and software to provide a network entity that operates as a socket listener. It is recognised that any computerised process that shares a resource (e.g. data) to one or more client processes can be classified as a server in the network system 10. The term server can also be generalized to describe a host that is deployed to execute one or more such programs, such that the host can be one or more configured computers that link other computers or electronic devices together via the network 11. The servers 14,16, can provide specialized services across the network 11, for example to private users inside a large organization or to public users via the Internet 11. In the network system 10, the servers can have dedicated functionality and/or can share functionality as described. Enterprise servers are servers that are used in a business context and can be run on/by any capable computer hardware. In the hardware sense, the word server typically designates computer models intended for running software applications under the heavy demand of a network 11 environment. In this client-server configuration one or more machines, either a computer or a computer appliance, share information with each other with one acting as a host for the other. While nearly any personal computer is capable of acting as a network server, a dedicated server will contain features making it more suitable for production environments. These features may include a faster CPU, increased high-performance RAM, and typically more than one large hard drive. More obvious distinctions include marked redundancy in power supplies, network connections, and even the servers themselves.

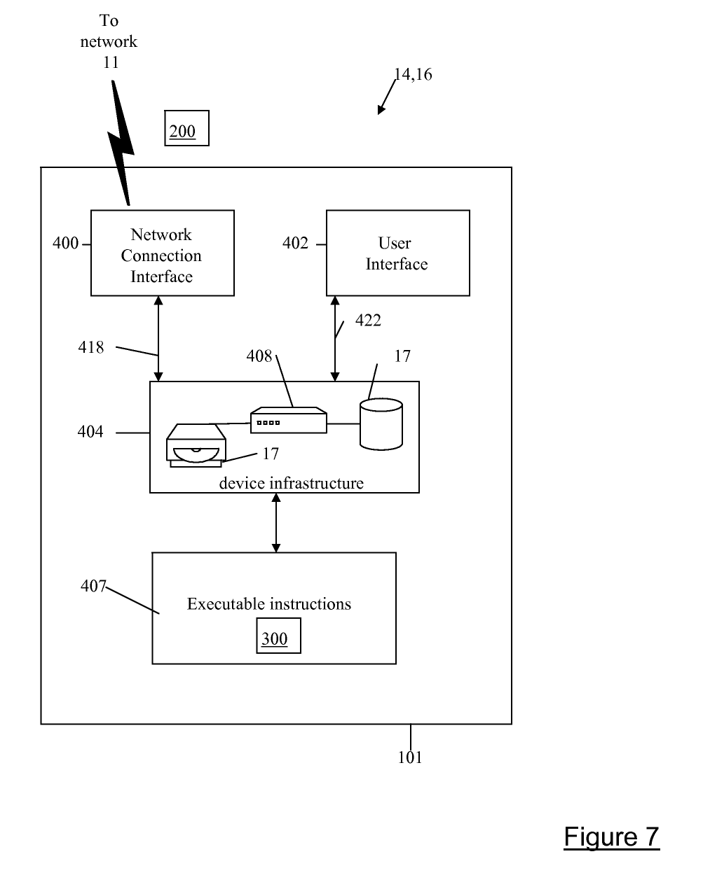

Referring to FIG. 7, a computing device 101 of the server 14,16 can include a network connection interface 400, such as a network interface card or a modem, coupled via connection 418 to a device infrastructure 404. The connection interface 400 is connectable during operation of the devices to the network 11 (e.g. an intranet and/or an extranet such as the Internet), which enables the devices to communicate with each other (e.g. that of servers 14,16 with respect to one another and the devices 12) as appropriate. The network 11 can support the communication of the communications 200, and the related content.

Referring again to FIG. 7, the device 101 can also have a user interface 402, coupled to the device infrastructure 404 by connection 422, to interact with a user (e.g. server administrator—not shown). The user interface 402 can include one or more user input devices such as but not limited to a QWERTY keyboard, a keypad, a stylus, a mouse, a microphone and the user output device such as an LCD screen display and/or a speaker. If the screen is touch sensitive, then the display can also be used as the user input device as controlled by the device infrastructure 404.

Referring again to FIG. 7, operation of the device 101 is facilitated by the device infrastructure 404. The device infrastructure 404 includes one or more computer processors 408 and can include an associated memory 422 (e.g. a random access memory). The computer processor 408 facilitates performance of the device 101 configured for the intended task (e.g. of the respective module(s) of the server 14,16) through operation of the network interface 400, the user interface 402 and other application programs/hardware 407 (e.g. server Web-service of the application 300 made available to the devices 12) of the device 101 by executing task related instructions. These task related instructions can be provided by an operating system, and/or software applications 407 located in the memory 422, and/or by operability that is configured into the electronic/digital circuitry of the processor(s) 408 designed to perform the specific task(s). Further, it is recognized that the device infrastructure 404 can include a computer readable storage medium 17 coupled to the processor 408 for providing instructions to the processor 408 and/or to load/update the instructions 407. The computer readable medium 17 can include hardware and/or software such as, by way of example only, magnetic disks, magnetic tape, optically readable medium such as CD/DVD ROMS, and memory cards. In each case, the computer readable medium 17 may take the form of a small disk, floppy diskette, cassette, hard disk drive, solid-state memory card, or RAM provided in the memory module 17. It should be noted that the above listed example computer readable mediums 17 can be used either alone or in combination.

Further, it is recognized that the computing device 101 can include the executable applications 407 comprising code or machine readable instructions for implementing predetermined functions/operations including those of an operating system and the server 14,16 modules, for example. The processor 408 as used herein is a configured device and/or set of machine-readable instructions for performing operations as described by example above, including those operations as performed by any or all of the modules 330,332,334,338,340,342. As used herein, the processor 408 may comprise any one or combination of, hardware, firmware, and/or software. The processor 408 acts upon information by manipulating, analyzing, modifying, converting or transmitting information for use by an executable procedure or an information device, and/or by routing the information with respect to an output device. The processor 408 may use or comprise the capabilities of a controller or microprocessor, for example. Accordingly, any of the functionality of the server 14,16 (e.g. modules) may be implemented in hardware, software or a combination of both. Accordingly, the use of a processor 408 as a device and/or as a set of machine-readable instructions is hereafter referred to generically as a processor/module for sake of simplicity. Further, it is recognised that the server 14,16 can include one or more of the computing devices 101 (comprising hardware and/or software) for implementing the modules, as desired.

It will be understood in view of the above that the computing devices 101 of the servers 14,16 may be, although depicted as a single computer system, may be implemented as a network of computer processors, as desired.

We claim:

1. A coordination server for facilitating the presentation of health related information over an electronic communication network to a plurality of users, such that each of the plurality of users is registered with a particular pharmacy store, the coordination server comprising:
a registration module configured for receiving electronic registration information of a user including user identification data and pharmacy store identification data of the particular pharmacy store at which the user is registered;
a user module configured for receiving electronic personal health information of the user including current user medication information and associated user condition information;
a confirmation module configured for confirming the accuracy of the electronic personal health information with at least one of a health care professional of the pharmacy store or the user;
a generation module configured for generating customized health related information for the user based on the confirmed electronic personal health information; and
a communication module configured for receiving an electronic request from the user for health related information and for sending an electronic response including the customized health related information.

2. The coordination server of claim 1, wherein the electronic request includes a query for further information pertaining to at least one of a specified disease or a health condition.

3. The coordination server of claim 2, wherein the customized health related information includes electronic data containing explanatory information related to the at least one of the specified disease or the health condition.

4. The coordination server of claim 3, wherein the electronic data includes lifestyle considerations for the user to facilitate in management of the at least one of the specified disease or the health condition.

5. The coordination server of claim 2, wherein the health related information includes electronic data for product information of the pharmacy store for one or more suggested products compatible with the at least one of the specified disease or the health condition.

6. The coordination server of claim 3, wherein the health related information includes product electronic data for product information of the pharmacy store for one or more suggested products compatible with the at least one of the specified disease or the health condition.

7. The coordination server of claim 5 further comprising the generation module configured with a product filter for inhibiting the inclusion of certain products considered incompatible with the confirmed electronic personal health information.

8. The coordination server of claim 5 further comprising the generation module configured with a product filter for promoting the inclusion of certain products considered compatible with the confirmed electronic personal health information.

9. The coordination server of claim 1 further comprising the communication module configured for sending electronic event information pertaining to one or more scheduled events associated with the pharmacy store.

10. The coordination server of claim 9, wherein the one or more scheduled events includes a scheduled clinic at the pharmacy store.

11. The coordination server of claim 9, wherein the one or more scheduled events includes a scheduled clinic at a location remote associated with the pharmacy store.

12. The coordination server of claim 9, wherein the electronic event information is customized by the generation module based on the confirmed electronic personal health information.

13. The coordination server of claim 12 further comprising the generation module configured with an event filter for inhibiting the inclusion of one or more scheduled events considered incompatible with the confirmed electronic personal health information.

14. The coordination server of claim 12 further comprising the generation module configured with an event filter for promoting the inclusion of one or more scheduled events considered compatible with the confirmed electronic personal health information.

15. The coordination server of claim 1, wherein the user identification data and the pharmacy store identification data is received over the electronic communication network from a pharmacy server associated with the pharmacy store.

16. The coordination server of claim 15, wherein confirmation of the electronic personal health information is received from the pharmacy server as a response to a confirmation request directed from the coordination server to the pharmacy server.

17. The coordination server of claim 1, wherein the electronic personal health information is originally received over the electronic communication network from a pharmacy server associated with the pharmacy store.

18. The coordination server of claim 17, wherein electronic update data to the electronic personal health information is received from the user over the electronic communication network and the confirmation module is configured for confirming the accuracy of the electronic update data with a health care professional of the pharmacy store.

19. The coordination server of claim 17, wherein the electronic update data includes update information to at least one of the user medication information and the associated user condition information.

20. The coordination server of claim 1, wherein the electronic personal health information is originally received over the electronic communication network from a user device of the user.

21. The coordination server of claim 20, wherein electronic update data to the electronic personal health information is received over the electronic communication network from a pharmacy server associated with the pharmacy store and the confirmation module is configured for confirming the accuracy of the electronic update data with the user.

22. The coordination server of claim 21, wherein the electronic update data includes update information to at least one of the user medication information and the associated user condition information.

23. The coordination server of claim 1, wherein electronic update data to the electronic personal health information is generated by the coordination server and the confirmation module is configured for confirming the accuracy of the electronic update data with the user.

24. The coordination server of claim 1 further comprising an application module configured for sending a health application over the electronic communication network to a communication device of the user, the health application configured for provisioning on the communication device for configuring the communication device for communication with the coordination server, the health application being customized based on the electronic registration information.

25. The coordination server of claim 24, wherein the health application is configured for communication with the communication module for sending the electronic request and receiving the electronic response, is configured for communication with the user module for sending the electronic personal health information, and is configured for communication with the user module for sending electronic update data to the electronic personal health information.

26. The coordination server of claim 25, wherein the electronic update data includes update information to at least one of the user medication information and the associated user condition information.

27. The coordination server of claim 1, wherein access to the coordination server over the electronic communication network by a communication device of the user is configured as a web service in communication with a browser application provisioned on the communication device.

28. The coordination server of claim 27 wherein the web service is configured for communication with the browser application for receiving the electronic request and sending the electronic response, is configured for communication with the browser application for receiving the electronic personal health information, and is configured for communication with the browser application for receiving electronic update data to the electronic personal health information.

29. The coordination server of claim 28, wherein the electronic update data includes update information to at least one of the user medication information and the associated user condition information.

30. The coordination server of claim 1, wherein the health care professional is selected from the group comprising: a pharmacist employed with the pharmacy store; a person associated with the pharmacist and employed at the pharmacy store; and a person associated with the pharmacist and employed at a location remote from the pharmacy store.

31. The coordination server of claim 1, wherein the electronic personal health information contains at least one of a dynamic user geographic location or a group parameter assigning the user as one of a specified group of users.

32. A method for facilitating the presentation of health related information over an electronic communication network to a plurality of users, such that each of the plurality of users is registered with a particular pharmacy store, the method comprising the steps of:
receiving electronic registration information of a user including user identification data and pharmacy store identification data of the particular pharmacy store at which the user is registered;
receiving electronic personal health information of the user including current user medication information and associated user condition information;
confirming the accuracy of the electronic personal health information with at least one of a health care professional of the pharmacy store or the user;
generating customized health related information for the user based on the confirmed electronic personal health information; and
receiving an electronic request from the user for health related information and for sending an electronic response including the customized health related information.
